(19) United States
(12) Patent Application Publication
(10) Pub. No.: US 2025/0256731 A1
(43) Pub. Date: Aug. 14, 2025

(54) DRIVER ASSISTANCE CONTROL DEVICE FOR VEHICLE, DRIVER ASSISTANCE CONTROL METHOD FOR VEHICLE, AND STORAGE MEDIUM OF SAME

(71) Applicant: TOYOTA JIDOSHA KABUSHIKI KAISHA, Toyota-shi (JP)

(72) Inventors: Keitaro NIKI, Toyota-shi (JP); Hiroto Katsuda, Toyota-shi (JP)

(73) Assignee: TOYOTA JIDOSHA KABUSHIKI KAISHA, Toyota-shi (JP)

(21) Appl. No.: 18/950,361

(22) Filed: Nov. 18, 2024

(30) Foreign Application Priority Data
Feb. 8, 2024 (JP) 2024-017654

(51) Int. Cl. B60W 50/10; B60W 10/04; B60W 10/20; B60W 30/12

(52) U.S. Cl. CPC B60W 50/10; B60W 10/04; B60W 10/20; B60W 30/12; B60W 2520/06; B60W 2520/14; B60W 2540/215; B60W 2552/30; B60W 2710/207; B60W 2720/106

(57) ABSTRACT

The driver assistance control device includes a controller that executes, as the driver assistance control, a steering assistance control (lane keeping control) that automatically changes a steering angle of the own vehicle and an acceleration assistance control (tracking inter-vehicle distance control) that automatically changes an acceleration of the own vehicle based on a traveling situation of the own vehicle. The controller learns a steering preference level indicating a degree of preference regarding steering of the driver, and changes a degree of steering assistance in the steering assistance control based on the learned steering preference level. The controller learns an acceleration preference level indicating a degree of preference related to acceleration of the driver, and changes a degree of acceleration support in the acceleration assistance control based on the learned acceleration preference level.

### CROSS-REFERENCE TO RELATED APPLICATION

This application claims priority to Japanese Patent Application No. 2024-017654 filed on Feb. 8, 2024, incorporated herein by reference in its entirety.

### BACKGROUND

### 1. Technical Field

The disclosure relates to a driver assistance control device, a driver assistance control method, and a storage medium of the same, of a vehicle, that assist a driver in driving the vehicle.

### 2. Description of Related Art

Conventionally, there is known a driver assistance control device that executes various types of driver assistance control including lane keeping control, tracking inter-vehicle distance control, and so forth. For example, one of the conventional driver assistance control devices changes a target travel line in the lane keeping control, and a target inter-vehicle distance in the tracking inter-vehicle distance control, in accordance with preferences of a driver (e.g., see Japanese Unexamined Patent Application Publication No. 2020-26154 (JP 2020-26154 A)).

### SUMMARY

However, the above-described conventional device cannot adjust a sense of steering (a degree of intensity of steering assistance) and/or a sense of acceleration (a degree of intensity of acceleration assistance) in the driver assistance control to match preferences of the driver.

The disclosure has been made to solve this problem. That is to say, an object of the disclosure is to provide a driver assistance control device, a driver assistance control method, and a program of the same, that are capable of maximally matching a feeling of driving in driver assistance control to preferences of a driver.

An aspect of a driver assistance control device for a vehicle, according to the disclosure, includes a controller (10) that executes, as driver assistance control, at least one of
steering assistance control (FIG. 4) for determining a steering control amount for automatically changing an actual steering angle of an own vehicle based on at least a traveling situation of the own vehicle (S440), and performing steering assistance for changing the actual steering angle based on the steering control amount, and
acceleration assistance control (S570) for determining a target acceleration for automatically changing an actual acceleration of the own vehicle based on at least the traveling situation, and for performing acceleration assistance such that the actual acceleration of the own vehicle matches the target acceleration.

The controller is further configured to,
when configured to execute the steering assistance control, learn a steering preference level indicating a degree of preference regarding steering by a driver of the own vehicle (S635), based on steering operations performed by the driver, and change a degree of intensity of the steering assistance (FIG. 3) by determining the steering control amount based on the steering preference level that is learned, and
when configured to execute the acceleration assistance control, learn an acceleration preference level indicating a degree of preference regarding acceleration by the driver of the own vehicle (S675), based on acceleration and deceleration operations by the driver, and change a degree of intensity of the acceleration assistance (S560) by determining the target acceleration based on the acceleration preference level that is learned.

Accordingly, the driver assistance control device according to the above aspect can automatically change sense of steering and/or sense of acceleration in the driver assistance control in accordance with preferences of the driver.

In the above description, names and/or signs used in the following embodiment are appended in parentheses to the components of the disclosure corresponding to the embodiment, in order to facilitate understanding of the disclosure. However, the components of the disclosure are not limited to those according to the embodiment defined by such names and/or signs. The disclosure also encompasses a driver assistance control method and a program of the same.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a driver assistance control device according to an embodiment of the present disclosure;

FIG. 2A is a diagram showing parameters used for lane keeping control;

FIG. 2B is a diagram illustrating a state of steering assistance control in lane keeping control;

FIG. 2C is a diagram illustrating a state of acceleration assistance control in tracking inter-vehicle distance control;

FIG. 3 is a routine executed by CPU of the driver assistance ECU shown in FIG. 1;

FIG. 4 is a routine executed by CPU of the driver assistance ECU shown in FIG. 1;

FIG. 5 is a routine executed by CPU of the driver assistance ECU shown in FIG. 1; and

FIG. 6 is a routine executed by CPU of the driver assistance ECU shown in FIG. 1.

### DETAILED DESCRIPTION OF EMBODIMENTS

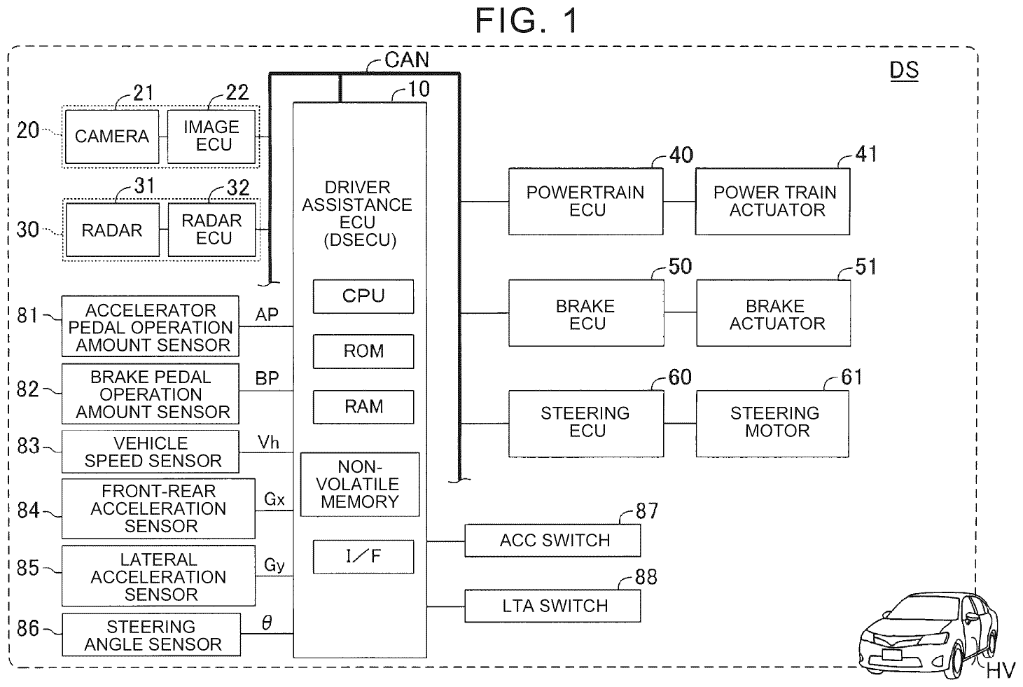

The “vehicle driver assistance control device DS (hereinafter referred to as “device DS”) according to the embodiment of the present disclosure includes the components illustrated in FIG. 1, and is applied to the own vehicle HV. The own vehicle HV may be any of a vehicle using an internal combustion engine as a power source, a battery electric vehicle, a hybrid electric vehicle, and the like.

As used herein, an “ECU” is an electronic control unit that includes a microcomputer that includes a processor (CPU), a ROM, RAM, and data-writable non-volatile memory. ECU are also referred to as controllers or computers. The plurality of ECU shown in FIG. 1 is connected to each other through a Controller Area Network (CAN) so as to be able to exchange information. Some or all of these ECU may be integrated into one ECU.

The driver assistance ECU 10 (hereinafter referred to as “DSECU”) transmits and receives signals to and from the components illustrated in FIG. 1, and executes lane keeping control (LTA), tracking inter-vehicle distance control (ACC), and the like.

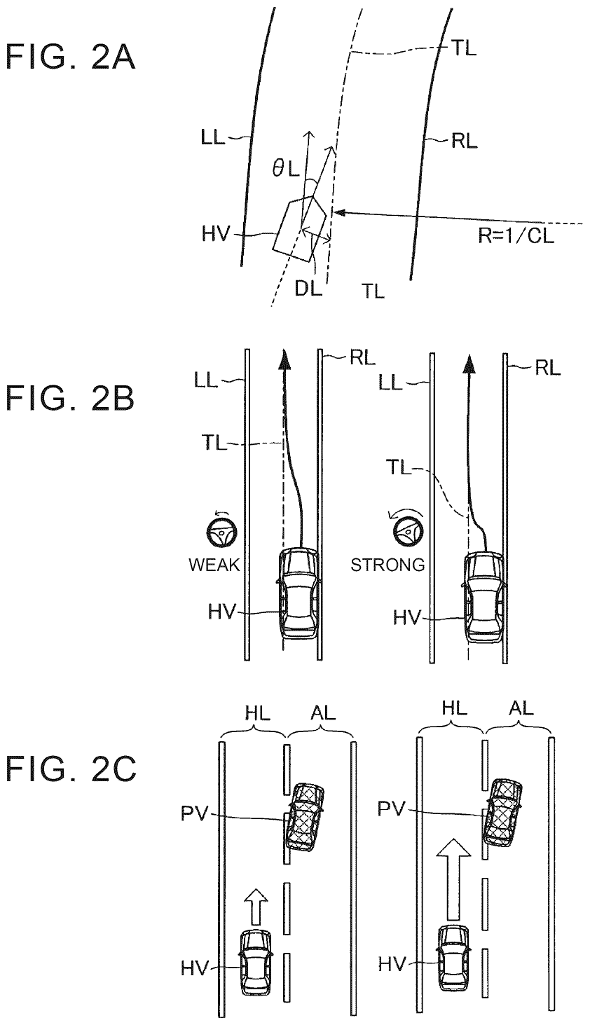

The camera device 20 includes a camera 21 and an image ECU 22. Each time a predetermined period of time elapses, the camera 21 acquires image data representing an image in front of the own vehicle HV. The image ECU 22 recognizes the “left boundary line LL and right boundary line RL” of the own lane, which is the lane on which the own vehicle HV travels, based on the image data. The image ECU 22 acquires the target travel line TL, the road curvature CL, the lateral deviation DL, the yaw angle deviation θL, and the like (refer to FIG. 2A) based on the image data, and generates the camera target information. The camera target information includes “position and type” and the like of a target existing in front of the own vehicle HV.

The radar device 30 is a well-known device that acquires information about a target object existing in front of the own vehicle HV by using a millimeter-wave band radio wave, and includes a radar 31 and a radar ECU 32. Each time a predetermined time elapses, the radar 31 transmits millimeter waves within a predetermined detection range and receives millimeter waves reflected by the target object. The radar ECU 32 acquires radar target information based on information about millimeter waves transmitted and received by the radar 31. The radar target information includes a distance to the target, an orientation of the target, a relative velocity of the target, and the like. DSECU generates fusion target information by integrating the camera target information and the radar target information.

The powertrain ECU 40 drives the powertrain actuator 41 in response to an instruction from DSECU or an operation of the accelerator pedal by the driver. Accordingly, the driving force generated by the driving device (the internal combustion engine, the electric motor, and the like) of the own vehicle HV is adjusted, and the acceleration of the own vehicle HV is controlled.

The brake ECU 50 drives the brake actuator 51 in response to an instruction from DSECU or an operation of the brake pedal by the driver. Accordingly, the braking force generated by the braking device on the own vehicle HV is adjusted, and the deceleration (negative acceleration) of the own vehicle HV is controlled.

The steering ECU 60 drives the steering motor 61 in response to an instruction from DSECU or an operation (steering operations) on the steering wheel by the driver. Accordingly, the steering device of the own vehicle HV is controlled, and the steering assist force and the steering angle of the own vehicle HV are changed.

DSECU receives the detected values or the outputted values of the “sensors and switches” below.
An accelerator pedal operation amount sensor 81 that detects an accelerator pedal operation amount AP of the own vehicle HV.
A brake pedal operation amount sensor 82 that detects a brake pedal operation amount BP of the own vehicle HV.
Vehicle speed sensor 83 that detects the speed of the own vehicle HV (that is, the own vehicle speed Vh).
The front-rear acceleration sensor 84 detects a front-rear acceleration (front-rear acceleration) Gx of the own vehicle HV.
A lateral acceleration sensor 85 for detecting a lateral acceleration Gy of the own vehicle HV in the vehicle width-direction.
A steering angle sensor 86 for detecting a steering angle 0 of a steering wheel of the own vehicle HV.
ACC switch 87 is an operating switch for turning on/off ACC.
An LTA switch 88, which is an operating switch for turning LTA on/off.

### Overview of Operation

The device DS executes lane keeping control, which is one of the steering assistance control, and tracking inter-vehicle distance control, which is one of the acceleration assistance control, as the driver assistance control.

The device DS changes the magnitude of the steering control amount in the lane keeping control and the acceleration of the own vehicle HV while a particular situation is occurring in the following vehicle-to-vehicle distance control in accordance with the driver's preference. The specifying situation is a situation in which the vehicle speed Vh does not increase to a predetermined target vehicle speed Vtgt from a state after a time point at which the preceding vehicle (following preceding vehicle) to be followed is present and the inter-vehicle distance between the own vehicle HV and the following preceding vehicle is maintained at the target inter-vehicle distance by the following inter-vehicle distance control, and the following preceding vehicle is no longer present. The situation in which the own vehicle speed Vh has not increased to the predetermined target vehicle speed Vtgt is a situation in which the specified acceleration condition is satisfied.

More specifically, the device DS learns (acquires) a “steering preference level” indicating a preference regarding steering of the driver based on actual steering operations of the driver. The device DS changes the steering control amount in the lane keeping control in accordance with the steering preference level to change the degree of steering assistance.

For example, when the learned steering preference level is weak, the device DS gently brings the own vehicle HV closer to the target travel line TL while the lane keeping control is being executed, as shown in the left-hand view of FIG. 2B. When the learned steering preference is strong, the device DS quickly brings the own vehicle HV closer to the target travel line TL while the lane keeping control is being executed, as shown in the right-hand view of FIG. 2B.

Further, the device DS learns an “acceleration preference level” representing a preference for acceleration of the driver based on the actual acceleration and deceleration operations of the driver. The device DS changes the target acceleration while the specific situation is occurring in accordance with the learned acceleration preference level to change the degree of acceleration assistance.

For example, when the learned acceleration preference level is weak, the device DS accelerates the own vehicle HV relatively slowly during the specified situation, as shown in the left-hand view of FIG. 2C. If the learned acceleration preference is strong, the device DS accelerates the own vehicle HV relatively rapidly during the specified situation, as shown in the right-hand view of FIG. 2C.

### Specific Operation

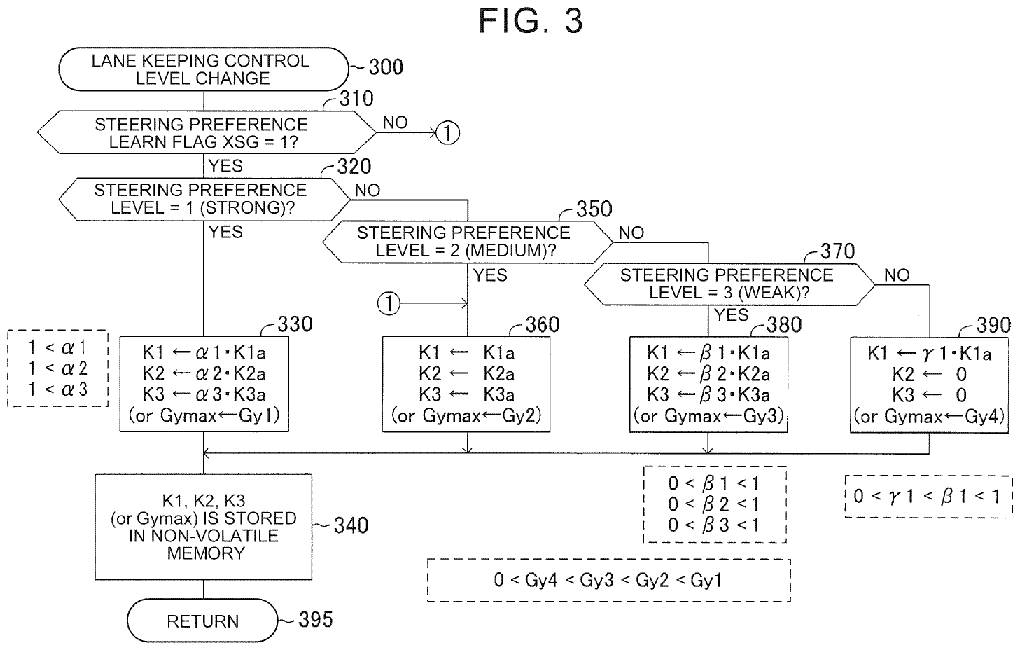

CPU of DSECU is executed every time a predetermined period (calculation cycle) dt elapses, as shown in FIG. 3 to FIG. 6. In the following description, “step” is referred to as “S”.

### Setting the Gain to Change the Degree of Steering Assistance

At a predetermined timing, CPU proceeds from S300 to S310 of FIG. 3 to determine whether or not the steering preference learn flag XSG is “1”. The value of the flag XSG is set to “1” when the steering preference level is learned (see S640). The value of the flag XSG and the value of the acceleration preference learning flag XGG, which will be described later, are set to “0” by an initialization routine (not shown) executed when the activation switch of the vehicle HV is changed from the off position to the on position. These flags are stored in DSECU non-volatile memories.

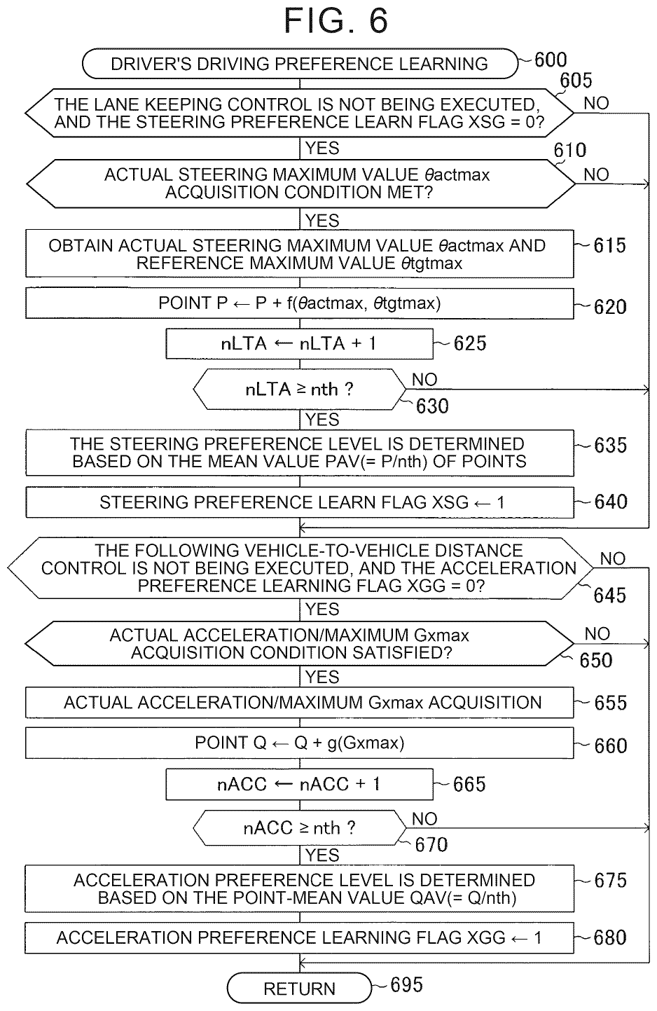

When the flag XSG is not “1”, CPU proceeds to S360 described later. On the other hand, when the value of the flag XSG is “1”, CPU proceeds from S310 to S320, and determines whether or not the steering preference level learned by the routine of FIG. 6 is “1” (strong).

If the steering preference is “1” (strong), CPU proceeds from S320 to S330. CPU sets the first gain K1 to “the product of the coefficient α1 and the positive value K1a”, sets the second gain K2 to “the product of the coefficient α2 and the positive value K2a”, and sets the third gain K3 to “the product of the coefficient α3 and the positive value K3a”. Each of the coefficients α1, α2, and α3 is a constant value greater than “1”. Next, CPU proceeds to S340 and stores the first to third gains (K1, K2, K3) used in calculating the target steering angle Otgt in DSECU non-volatile memories. After that, CPU proceeds to S395 and ends the routine once.

If the learned steering preference level is not “1” (strong), CPU proceeds from S320 to S350 and determines whether the learned steering preference level is “2” (medium). If the learned steering preference level is “2” (medium), CPU proceeds from S350 to S360, sets the first gain K1 to the value K1a, sets the second gain K2 to the value K2a, and sets the third gain K3 to the value K3a. CPU then proceeds to S340 and S395.

If the learned steering preference level is not “2” (middle), CPU proceeds from S350 to S370 and determines whether the learned steering preference level is “3” (weak). If the learned steering preference level is “3” (weak), CPU proceeds from S370 to S380 and sets the first gain K1 to “the product of the factor β1 and the value K1a”. CPU sets the second gain K2 to “the product of the coefficient β2 and the value K2a”, and sets the third gain K3 to “the product of the coefficient β3 and the value K3a”. Each of the coefficients β1, β2, and β3 has a constant value greater than “0” and less than “1”. CPU then proceeds to S340 and S395.

If the learned steering preference level is not “3” (weak), the learned steering preference level is “4” (weak). Here, CPU proceeds from S370 to S390, sets the first gain K1 to “the product of the coefficient γ1 and the value K1a”, and sets the second gain K2 and the third gain K3 to “0”, respectively. The coefficient γ1 is a constant value larger than “0” and smaller than the coefficient β1. CPU then proceeds to S340 and S395.

### Lane Keeping Control

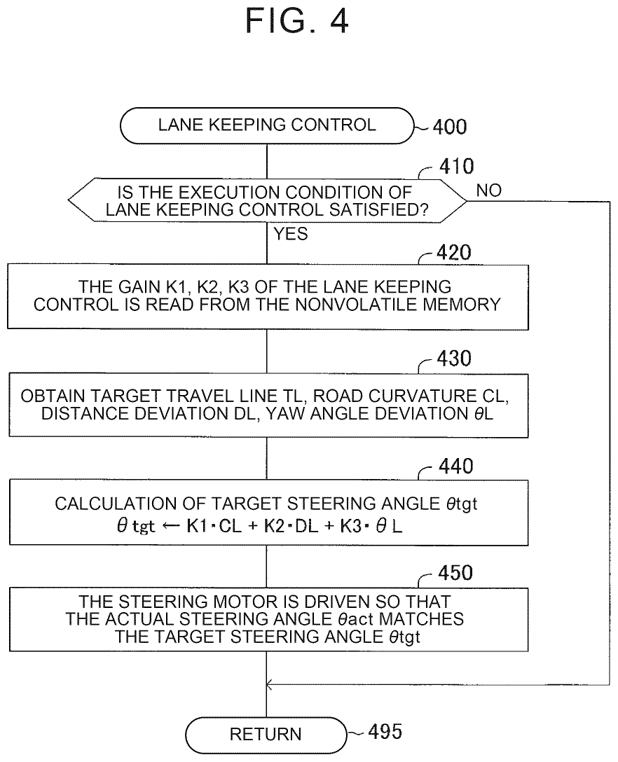

At a predetermined timing, CPU proceeds from S400 to S410 of FIG. 4 to determine whether or not the lane keeping control is executed. For example, the execution condition of the lane keeping control is established when LTA switch 88 is operated to set the lane keeping control to ON, and both of the “left boundary line LL and right boundary line RL” of the own lane shown in FIG. 2A are recognized by the camera device 20.

When the lane keeping control is not executed, CPU proceeds directly from S410 to S495 and terminates the routine. On the other hand, when the execution condition of the lane keeping control is satisfied, CPU executes the process of “S420 to S450” and proceeds to S495.
S420: CPU reads the first to third gains (K1, K2, K3) from the nonvolatile memories.

S430: CPU acquires the target travel line TL, the road curvature CL, the lateral deviation DL, and the yaw angle deviation θL of the lane keeping control from the image data (or the image ECU 22). As shown in FIG. 2A, the target travel line TL is a line connecting the center positions of the left boundary line LL and the right boundary line RL in the lane widthwise direction. The road curvature CL is the curvature of the target travel line TL (the inverse of the radii of the target travel line TL). The lateral deviation DL is a distance between a center position (for example, a center position between the left front wheel and the right front wheel) of the own vehicle HV in the vehicle width direction and the target travel line TL. The yaw angle deviation θL is an angle formed by the tangential direction of the target travel line TL and the traveling direction of the own vehicle HV.

S440: CPU calculates the target steering angle θtgt as the steering control amount by substituting the values of the first to third gains (K1, K2, K3) and the road curvature CL, the lateral deviation DL, and the yaw angle deviation θL into Equation (1) below.

$$θ tgt = K 1 \cdot CL + K 2 \cdot DL + K 3 \cdot θ L \qquad ( 1 )$$

S450: CPU sends an instruction to the steering ECU 60 so that the actual steering angle θact matches the target steering angle θtgt. The steering ECU 60 obtains the target steering torque Tqtgt from the look-up table on the basis of the actual steering angle θact, the target steering angle θtgt, the own vehicle speed Vh, and the like, and causes the steering motor 61 to generate a torque coinciding with the target steering torque Tqtgt. Consequently, the actual steering angle θact coincides with the target steering angle θtgt, and the own vehicle HV is caused to travel along the target travel line TL.

As described above, the first to third gains (K1, K2, K3) are changed according to the learned steering preference level, and consequently, the steering control amounts are changed according to the learned steering preference level. Therefore, since the degree of steering assistance changes according to the learned steering preference level, lane keeping control as the steering assistance control according to the driver's preference is executed.

### Follow-Up Vehicle Distance Control

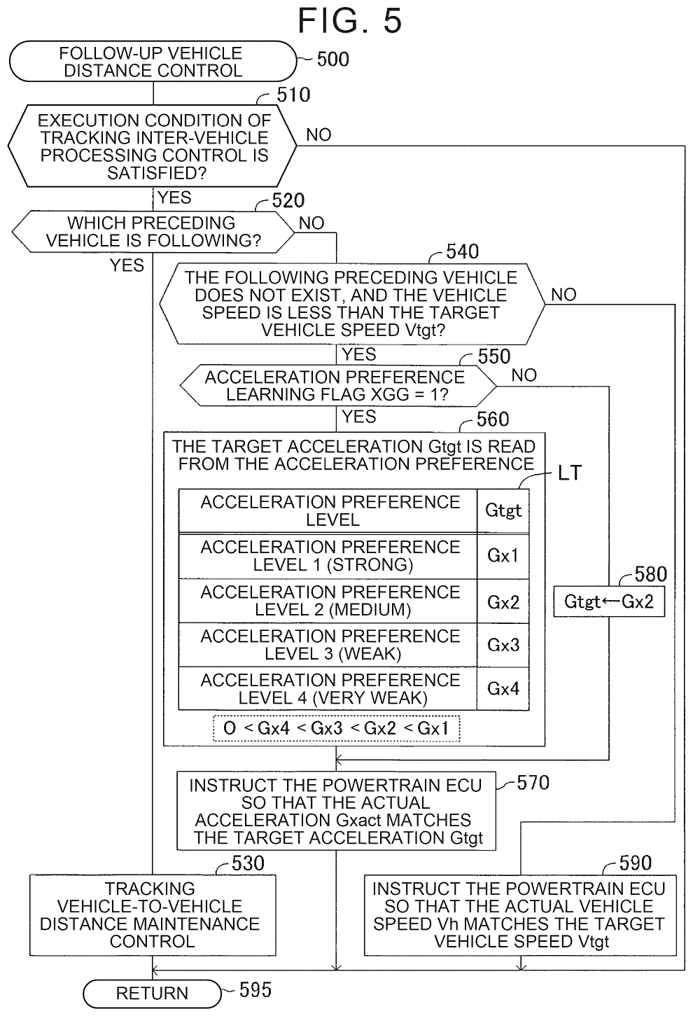

At a predetermined timing, CPU proceeds from S500 in of FIGS. 5 to S510 to determine whether or not the following inter-vehicle distance control is satisfied. For example, the following inter-vehicle distance control is executed when the vehicle speed Vh is equal to or higher than the vehicle speed threshold Vth and ACC switch 87 is operated to set the following inter-vehicle distance control to ON.

If the following inter-vehicle distance control is not executed, CPU proceeds directly from S510 to S595 and terminates the routine. On the other hand, when the following vehicle-to-vehicle distance control is executed, CPU proceeds from S510 to S520 and determines whether or not there is a following preceding vehicle based on the fusion target information. The following preceding vehicle is another vehicle that travels in the own lane and immediately before the own vehicle HV and is present within a predetermined range from the own vehicle HV.

When the following preceding vehicle is present, CPU proceeds from S520 to S530, and controls the acceleration of the own vehicle HV so that the inter-vehicle distance between the following preceding vehicle and the own vehicle HV coincides with the predetermined target inter-vehicle distance. JP-A-2020-26154, JP-A-2014-148293, and JP-A-4172434 are referred to. After that, CPU proceeds to S595 and ends the routine once.

On the other hand, when the following preceding vehicles do not exist, CPU proceeds from S520 to S540 to determine whether or not the above-described specified situation has occurred at the present time.

If a particular situation has occurred, CPU proceeds from S540 to S550 and determines whether the acceleration preference learn flag XGG is “1”. The value of this flag XGG is set to “1” when the learning of the acceleration preference level is completed (see S680). When the value of the flag XGG is “1”, CPU proceeds from S550 to S560 and determines the target acceleration Gtgt based on the “acceleration preference level learned by the routine of FIG. 6”.

More specifically, DSECU stores the lookup table LT in its ROM (see S560). The ROM is an example of a storage medium. CPU determines the target acceleration Gtgt by applying the learned acceleration preference level to the lookup table LT. For example, when the acceleration preference is “1” (strong), the acceleration Gx1 is acquired as the target acceleration Gtgt. When the learned acceleration preference level is “2” (medium), the acceleration Gx2 is acquired as the target acceleration Gtgt. When the learned acceleration preference is “3” (weak), the acceleration Gx3 is acquired as the target acceleration Gtgt. When the learned acceleration preference is “4” (extremely weak), the acceleration Gx4 is acquired as the target acceleration Gtgt. The following equation (2) holds between the accelerations Gx1 to Gx4.

$$0 < Gx 4 < Gx 3 < Gx 2 < Gx 1 \qquad ( 2 )$$

Next, CPU proceeds to S570 and controls the acceleration of the own vehicle HV via the powertrain ECU 40 so that the actual acceleration Gx of the own vehicle HV coincides with the target acceleration Gtgt until the own vehicle speed Vh is increased to the target vehicle speed Vtgt. CPU then proceeds to S595.

When CPU proceeds to S550, CPU proceeds from S550 to S580 when the acceleration preference learn flag XGG is not “1” (is “0”), and sets the target acceleration Gtgt to the acceleration Gx2. CPU then proceeds to S570 and S595.

When S570 process continues to be executed, the own vehicle speed Vh gradually increases to reach the target vehicle speed Vtgt. When CPU proceeds to S540, S540 determines “No” and proceeds to S590. In S590, CPU executes a known constant speed travel control for controlling the acceleration of the own vehicle HV so that the own vehicle speed Vh matches the target vehicle speed Vtgt. CPU then proceeds to S595.

As described above, CPU sets the target acceleration Gtgt for the period in which the above-described specified situation is occurring in accordance with the learned acceleration preference level. Therefore, the intensity of the acceleration support of the acceleration assistance control included in the following inter-vehicle distance control is changed in accordance with the learned acceleration preference level.

### Learning the Steering Preference Level

At a predetermined timing, CPU proceeds from S600 to S605 of FIG. 6 to determine whether or not the steering preference level-learning condition is satisfied. The steering preference level is learned when the lane keeping control is not being executed (not being executed) and the steering preference learning flag XSG is “0” at the present time.

When the learning condition of the steering preference level is satisfied, CPU proceeds from S605 to S610, and determines whether or not the acquisition condition of the actual steering maximum value θactmax is satisfied. The actual steering maximum value θactmax is a maximum value of the magnitude (|θact|) of the actual steering angle θact. The acquisition condition of the actual steering maximum value θactmax is a condition that is satisfied when a traveling situation occurs in which the magnitude (|θtgt|) of the target steering angle θtgt takes the “reference steering maximum value θtgtmax” which is the maximum value thereof. The magnitude of the target steering angle θtgt is calculated based on Equation (1) above, in which the first gain K1 is set to the value K1a, the second gain K2 is set to the value K2a, and the third gain K3 is set to the value K3a, assuming that the lane keeping control is executed.

When the actual steering maximum value θactmax is satisfied, CPU performs the “S615 to S625 process” described below, and proceeds to S630.

S615: CPU acquires the actual steering maximum value θactmax and the reference steering maximum value θtgtmax. The actual steering maximum value θactmax is a value between a first time before a predetermined time from a time (maximum time) when the calculated target steering angle θtgt becomes the reference steering maximum value θtgtmax and a second time after a predetermined time from the maximum time.
S620: CPU updates the point P by adding a value (=f(θactmax, θtgtmax)) determined based on the actual steering maximum value θactmax, the reference steering maximum value θtgtmax, and the function f to the point P at that time.

The function f is as follows: R is a positive predetermined value.

$$When θ tgt max + 2 \cdot R \leq θ act max : f ( θ act max , θ tgt max ) = 2$$

$$When θ tgt max + R \leq θ act max < θ tgt max + 2 \cdot R : f ( θ act max , θ tgt max ) = + 1$$

$$When θ tgt max - R \leq θ act max < θ tgt max + R : f ( θ act max , θ tgt max ) = 0$$

$$When θ tgt max - 2 \cdot R \leq θ act max < θ tgt max - R : f ( θ act max , θ tgt max ) = - 1$$

$$When θ act max < θ tgt max - 2 \cdot R : f ( θ act max , θ tgt max ) = - 2$$

S625: CPU increases the number of steering samples nLTA by “1”. Note that the point P and the number of steering samples nLTA are set to “0” at the time of shipping of the own vehicle HV, and are stored in DSECU non-volatile memories.

Next, CPU proceeds to S630 and determines whether or not the number of steered samples nLTA is equal to or greater than a predetermined threshold nth. If the number of steering samples nLTA is greater than or equal to the threshold nth, CPU proceeds from S630 to S635 and determines the steering preference level based on the mean value PAV(=P/nth of the point P, for example, as follows.
When 1.5≤mean value PAV: steering preference level=1 (strong)
When −0.2≤mean value PAV<1.5: steering preference level=2 (medium)
When −0.8≤mean value PAV<−0.2: steering preference level=3 (weak)
When mean value PAV<−0.8: steering preference level=4 (extreme weakness)
That is, the larger the mean value PAV, the stronger the steering preference level (approaching “1”).

Next, CPU proceeds to S640 and sets the steering preference learn flag XSG to “1”. CPU then proceeds to S645. If CPU determines “No” in any of S605, S610 and S630 steps, the process proceeds directly to S645 from the step determined as “No”.

### Learning Acceleration Preference Levels

In S645, CPU determines whether or not the training condition of the acceleration preference level is satisfied. The learning condition of the acceleration preference level is satisfied when the following inter-vehicle distance control is not being executed (not being executed) and the value of the acceleration preference learning flag XGG is “0” at the present time.

When the learning condition of the acceleration preference level is satisfied, CPU proceeds from S645 to S650, and determines whether or not the acquisition condition of the actual acceleration maximum value Gxmax is satisfied. The actual acceleration maximum value Gxmax is a maximum value of the actual front-rear acceleration Gx. The condition for acquiring the actual acceleration maximum value Gxmax is a condition that is satisfied when a state in which the own vehicle speed Vh is a speed within the predetermined range and the distance between the preceding vehicle traveling immediately before the own vehicle HV and the own vehicle HV is a distance within the predetermined range continues for a first threshold time or longer, and then a situation occurs in which the preceding vehicle is no longer present.

When the conditions for obtaining the actual acceleration-maximum-value Gxmax are satisfied, CPU performs the “S655 to S665 process” described below, and proceeds to S670.
S655: CPU acquires, as the actual acceleration maximum value Gxmax, the maximum value of the actual acceleration Gx in the period from the time when the acquisition condition of the actual acceleration maximum value Gxmax is satisfied to the time when the predetermined time elapses.
S660: CPU updates the point Q by adding a value (=g(Gxmax)) determined based on the actual acceleration maximum value Gxmax and the function g to the point Q at that time.

The function g is as follows: G0 is a positive reference acceleration, and T is a positive predetermined value.

$$When G 0 + 2 \cdot T \leq Gx max : g ( Gx max ) = + 2$$

$$When G 0 + T \leq Gx max < G 0 + 2 \cdot T : g ( Gx max ) = + 1$$

$$When G 0 - T \leq Gx max < G 0 + T : g ( Gx max ) = 0$$

$$When G 0 - 2 \cdot T \leq Gx max < G 0 - T : g ( Gx max ) = - 1$$

$$When Gx max < - 2 \cdot T : g ( Gx max ) = - 2$$

S665: CPU increases the number of acceleration samples nACC by “1”. CPU then proceeds to S670 to determine whether the number of acceleration samples nACC is greater than or equal to the threshold nth. Note that the point Q and the acceleration-sample-number nACC are set to “0” at the time of shipping of the own vehicle HV, and are stored in DSECU non-volatile memories. The non-volatile memories are examples of a storage medium. If the number of acceleration samples nACC is greater than or equal to the threshold nth, CPU proceeds from S670 to S675 and determines the acceleration preference level based on the mean value QAV(=Q/nth) of the point Q, for example, as follows.
When 1.5≤mean value QAV: Acceleration preference level=1 (strong)
When −-0.2≤mean value QAV<1.5: Acceleration preference level=2 (medium)
When −0.8≤mean value QAV<−0.2: Acceleration preference level=3 (weak)
When mean value QAV<−0.8: Acceleration preference level=4 (extremely weak)
That is, the higher the mean QAV, the stronger the acceleration preference (approaching “1”).

Next, CPU proceeds to S680 and sets the acceleration preference learn flag XGG to “1”. After that, CPU proceeds to S695 and ends the routine once. If CPU determines “No” in any of S645, S650 and S670 steps, the process proceeds to S695 from the step determined as “No”.

As described above, the device DS can automatically change the degree of steering assistance in the steering assistance control in accordance with the steering preference level of the learned driver. Further, the device DS can automatically change the intensity of the acceleration support in the acceleration assistance control in accordance with the acceleration preference level of the learned driver.

The present disclosure is not limited to the above-described embodiments, and various modifications can be adopted within the scope of the present disclosure. For example, the present disclosure is also applicable to a vehicle that is in an automated driving state or a vehicle that is in a state in which a driving mode is transitioned from automated driving to manual driving by a driver.

Further, the present disclosure can also be applied to “lane departure prevention control or lane change assistance control” which is a steering assistance control, and can also be applied to a scene in which acceleration is performed in normal constant speed travel control which is an acceleration assistance control. The scene in which the acceleration is performed in the normal constant speed travel control which is the acceleration assistance control is, for example, the resumption time (that is, the resumption time of the constant speed travel control) performed after the cancellation of the constant speed travel control. Further, the device DS may be configured to be able to change only one of the “steering assistance strength degree and acceleration assistance strength degree” in accordance with the respective preference levels.

The steering preference level may be learned on the basis of “a position, a moving amount, a moving speed, a lateral acceleration Gy, a yaw rate, and the like of the own vehicle HV in the lane widthwise direction with respect to the shape (curvature) of the own lane during the manual driving by the driver while the lane keeping control is not being executed. Further, the steering preference level may be learned based on an intervention frequency of the steering operations by the driver during execution of the lane keeping control.

The acceleration preference level may be learned on the basis of “an accelerator pedal operation amount, a brake pedal operation amount, an inter-vehicle distance with a preceding vehicle, and the like” during manual driving by the driver while the following inter-vehicle distance control is not being executed. Further, the acceleration preference level may be learned based on “an intervention frequency of an acceleration operation, a braking intervention frequency by a deceleration operation, and the like” during execution of the following inter-vehicle distance control.

Further, the device DS may determine the upper limit (allowable) lateral acceleration Gymax during the steering assistance control based on the steering preference level (see in parentheses of S330, S360, S380, S390), and determine the steering control amount of the steering assistance control so that the magnitude of the actual lateral acceleration during the steering assistance does not exceed the upper limit lateral acceleration. Further, the device DS may determine the upper limit (allowable) yaw rate during the steering assistance control based on the steering preference level, and determine the steering control amount of the steering assistance control so that the magnitude of the actual yaw rate during the steering assistance does not exceed the upper limit yaw rate.

What is claimed is:

1. A driver assistance control device for a vehicle that is equipped with a controller that executes, as driver assistance control, at least one of
steering assistance control for determining a steering control amount for automatically changing an actual steering angle of an own vehicle based on at least a traveling situation of the own vehicle, and performing steering assistance for changing the actual steering angle based on the steering control amount, and
acceleration assistance control for determining a target acceleration for automatically changing an actual acceleration of the own vehicle based on at least the traveling situation, and for performing acceleration assistance for controlling the actual acceleration such that the actual acceleration of the own vehicle matches the target acceleration, wherein the controller is configured to,
when configured to execute the steering assistance control, learn a steering preference level indicating a degree of preference regarding steering by a driver of the own vehicle, based on steering operations performed by the driver, and change a degree of intensity of the steering assistance by determining the steering control amount based on the steering preference level that is learned, and
when configured to execute the acceleration assistance control, learn an acceleration preference level indicating a degree of preference regarding acceleration by the driver of the own vehicle, based on acceleration and deceleration operations by the driver, and change a degree of intensity of the acceleration assistance by determining the target acceleration based on the acceleration preference level that is learned.

2. The driver assistance control device according to claim 1, wherein
the controller is configured to execute, as the steering assistance control, lane keeping control for changing the steering control amount such that the own vehicle travels along a predetermined target travel line set in a lane in which the own vehicle is traveling, and
the controller is further configured to
acquire a road curvature (CL) that is a curvature of the target traveling line, a lateral deviation (DL) that is a distance in a lane width direction between the target travel line and the own vehicle, and a yaw angle deviation (θL) that is an angle between a tangential direction of the target traveling line and a traveling direction of the own vehicle, and calculate the steering control amount in the lane keeping control, based on
a first term (K1·CL) that is a product of the road curvature (CL) and a first gain (K1),
a second term (K2·DL) that is a product of the lateral deviation (DL) and a second gain (K2), and
a third term (K3·θL) that is a product of the yaw angle deviation (θL) and a third gain (K3), and
change the first gain, the second gain, and the third gain to change the degree of intensity of the steering assistance, in accordance with the steering preference level.

3. The driver assistance control device according to claim 1, wherein the controller is configured to perform, as the acceleration assistance control, following traveling in which the own vehicle is caused to follow a preceding vehicle that is travelling immediately ahead of the own vehicle, so as to maintain a predetermined inter-vehicle distance between the own vehicle and the preceding vehicle, and also, when the preceding vehicle is no longer present in a state in which the own vehicle is being caused to perform following traveling of the preceding vehicle, perform the acceleration assistance until speed of the own vehicle reaches a predetermined target vehicle speed.

4. A driver assistance control method that executes, as driver assistance control, at least one of steering assistance control for determining a steering control amount for automatically changing an actual steering angle of an own vehicle based on at least a traveling situation of the own vehicle, and performing steering assistance for changing the actual steering angle based on the steering control amount, and acceleration assistance control for determining a target acceleration for automatically changing an actual acceleration of the own vehicle based on at least the traveling situation, and for performing acceleration assistance for controlling the actual acceleration such that the actual acceleration of the own vehicle matches the target acceleration, the driver assistance control method comprising:
when executing the steering assistance control, learning a steering preference level indicating a degree of preference regarding steering by a driver of the own vehicle, based on steering operations performed by the driver, and changing a degree of intensity of the steering assistance by determining the steering control amount based on the steering preference level that is learned; and
when executing the acceleration assistance control, learning an acceleration preference level indicating a degree of preference regarding acceleration by the driver of the own vehicle, based on acceleration and deceleration operations by the driver, and changing a degree of intensity of the acceleration assistance by determining the target acceleration based on the acceleration preference level that is learned.

5. A non-transitory storage medium storing a program that is executed by a computer installed in an own vehicle,
the program causing the computer to execute, as driver assistance control, at least one of steering assistance control for determining a steering control amount for automatically changing an actual steering angle of the own vehicle based on at least a traveling situation of the own vehicle, and performing steering assistance for changing the actual steering angle based on the steering control amount, and acceleration assistance control for determining a target acceleration for automatically changing an actual acceleration of the own vehicle based on at least the traveling situation, and for performing acceleration assistance for controlling the actual acceleration such that the actual acceleration of the own vehicle matches the target acceleration, and
the program further causing the computer to execute,
when executing the steering assistance control, learning a steering preference level indicating a degree of preference regarding steering by a driver of the own vehicle, based on steering operations performed by the driver, and changing a degree of intensity of the steering assistance by determining the steering control amount based on the steering preference level that is learned, and
when executing the acceleration assistance control, learning an acceleration preference level indicating a degree of preference regarding acceleration by the driver of the own vehicle, based on acceleration and deceleration operations by the driver, and changing a degree of intensity of the acceleration assistance by determining the target acceleration based on the acceleration preference level that is learned.
